(19) United States
(12) Patent Application Publication
(10) Pub. No.: US 2019/0303381 A1
(43) Pub. Date: Oct. 3, 2019

(54) DATA COMPRESSION METHOD, APPARATUS FOR DATA COMPRESSION, AND NON-TRANSITORY COMPUTER-READABLE STORAGE MEDIUM FOR STORING PROGRAM

(71) Applicant: FUJITSU LIMITED, Kawasaki-shi (JP)

(72) Inventor: Minoru Nakamura, Kawasaki (JP)

(73) Assignee: FUJITSU LIMITED, Kawasaki-shi (JP)

(21) Appl. No.: 16/264,724

(22) Filed: Feb. 1, 2019

(30) Foreign Application Priority Data
Mar. 30, 2018 (JP) 2018-069864

(51) Int. Cl. G06F 16/25; G06F 16/22

(52) U.S. Cl. CPC G06F 16/258; G06F 16/2246

(57) ABSTRACT

A data compression method includes: specifying a structure of a group included in semistructured data, based on a data kind and a data type of each data in the group; setting a first identifier unique to each structure and setting a second identifier for a pair of the data kind and the data type of each data in the structure; storing the data in the group in different storage areas for each pair of the first identifier corresponding to the group and the second identifier corresponding to the data; and compressing the data for each storage area.

### CROSS-REFERENCE TO RELATED APPLICATION

This application is based upon and claims the benefit of priority of the prior Japanese Patent Application No. 2018-69864, filed on Mar. 30, 2018, the entire contents of which are incorporated herein by reference.

### FIELD

The embodiment discussed herein is related to a data compression method, an apparatus for data compression, and a non-transitory computer-readable storage medium for storing a program.

### BACKGROUND

For data storage in a relational database management system (RDBMS), an N-array storage model or a decomposition storage model is used. Meanwhile, as for a document DB storing semistructured data such as JavaScript (registered trademark) object notation (JSON) and extensible markup language (XML), the N-array storage model is usually used.

As a related art, there has been proposed a technology of inferring a schema of semistructured data, dynamically generating a cumulative schema, and combining the inferred schema with the cumulative schema.

As a related art, there has been proposed a technology of dividing attribute-specific data into files to be held, and holding a data structure as schema information.

As a related art, there has been proposed a technology of detecting a delimiter from a specified region, and coding a data string in the specified region based on the detected delimiter and structural information.

Examples of the related art include Japanese National Publication of International Patent Application No. 2015-508529 and Japanese Laid-open Patent Publication Nos. 2011-13758 and 2009-75887.

### SUMMARY

According to an aspect of the embodiments, a data compression method includes: specifying a structure of a group included in semistructured data, based on a data kind and a data type of each data in the group; setting a first identifier unique to each structure and setting a second identifier for a pair of the data kind and the data type of each data in the structure; storing the data in the group in different storage areas for each pair of the first identifier corresponding to the group and the second identifier corresponding to the data; and compressing the data for each storage area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating an N-array storage model and a decomposition storage model;

FIG. 2 is a diagram illustrating an example of a basic data type document;

FIG. 3 is a diagram illustrating explanation of field values;

FIG. 4 is a diagram illustrating an example of a document including a nested structure of an object;

FIG. 5 is a diagram illustrating an example of a document including an array;

FIG. 6 is a diagram illustrating an example of field definition;

FIG. 7 is a diagram illustrating a first example of a document representing a schema;

FIG. 8 is a diagram illustrating a second example of a document representing a schema;

FIG. 9 is a diagram illustrating an example of a system configuration according to the embodiment;

FIG. 10 is a diagram illustrating a configuration example of an information processor according to the embodiment;

FIG. 11 is a diagram explaining information used in the embodiment;

FIG. 12 is a diagram illustrating an example of a field name/field ID tree;

FIG. 13 is a diagram illustrating an example of a field ID/field name table;

FIG. 14 is a diagram illustrating an example of a field ID array;

FIG. 15 is a diagram illustrating an example of a field ID array/schema ID tree;

FIG. 16 is a diagram illustrating an example of a schema management table;

FIG. 17 is a diagram illustrating an example of files to store data;

FIG. 18 is a diagram illustrating an example of a data storage method;

FIG. 19 is a diagram illustrating an example of a field name/field ID tree of a document with a nested object;

FIG. 20 is a diagram illustrating an example of a field ID/field name table of a document with a nested object;

FIG. 21 is a diagram illustrating an example of a schema management table of a document with a nested object;

FIG. 22 is a diagram illustrating an example of a data storage method for a document with a nested object;

FIG. 23 is a diagram illustrating an example of abbreviations of data types of an array;

FIG. 24 is a diagram illustrating an example of a document including a basic data type array;

FIG. 25 is a diagram illustrating an example of a field ID/field name table of a document including a basic data type array;

FIG. 26 is a diagram illustrating an example of a schema management table of a document including a basic data type array;

FIG. 27 is a diagram illustrating an example of a data storage method for a document including a basic data type array;

FIG. 28 is a diagram illustrating an example of a document including an object type array;

FIG. 29 is a diagram illustrating an example of a field ID/field name table of the document including the object type array;

FIG. 30 is a diagram illustrating an example of a schema management table of the document including the object type array;

FIG. 31 is a diagram illustrating an example of a data storage method for the document including the object type array;

FIG. 32 is a flowchart illustrating an example of a processing flow according to the embodiment;

FIG. 33 is a flowchart illustrating an example of compression preprocessing;

FIG. 34 is a flowchart illustrating an example of first generation processing;

FIG. 35 is a flowchart illustrating an example of second generation processing;

FIG. 36 is a flowchart illustrating an example of storage processing;

FIG. 37 is a flowchart illustrating an example of restoration processing;

FIG. 38 is a flowchart illustrating an example of decompression processing;

FIG. 39 is a diagram illustrating a first example of a document to be applied to the processing of the embodiment;

FIGS. 40A and 40B are a diagram illustrating a processing example when the processing of the embodiment is performed on a document;

FIG. 41 is a diagram illustrating a second example of a document to be applied to the processing of the embodiment;

FIG. 42 is a diagram (Part 1) illustrating a storage processing example when the storage processing of the embodiment is performed on a document;

FIG. 43 is a diagram (Part 2) illustrating a storage processing example when the storage processing of the embodiment is performed on the document;

FIG. 44 is a diagram illustrating a first example of a system configuration;

FIG. 45 is a diagram illustrating a second example of a system configuration; and

FIG. 46 is a diagram illustrating an example of a hardware configuration of the information processor.

### DESCRIPTION OF EMBODIMENTS

Data using a decomposition storage model has higher compression efficiency than data using an N-array storage model. However, as for semistructured data, a schema is changed by adding or changing data, or the like. Therefore, it is difficult to use the decomposition storage model.

As one aspect of the embodiment, it is an object thereof to improve the compression efficiency of the semistructured data.

In the RDBMS, for example, one piece of data is called a record or a tuple. One record includes a plurality of attributes such as “name”, “birth date”, and “address”. A set of such records is called a table or a relation. In the RDBMS, operations such as insertion, deletion, and retrieval of records are executed on the table.

Such a table is a “set of records” as a design concept, but may also be interpreted as secondary information of rows and columns. Attributes of the records are called columns, and each of the records is called a row.

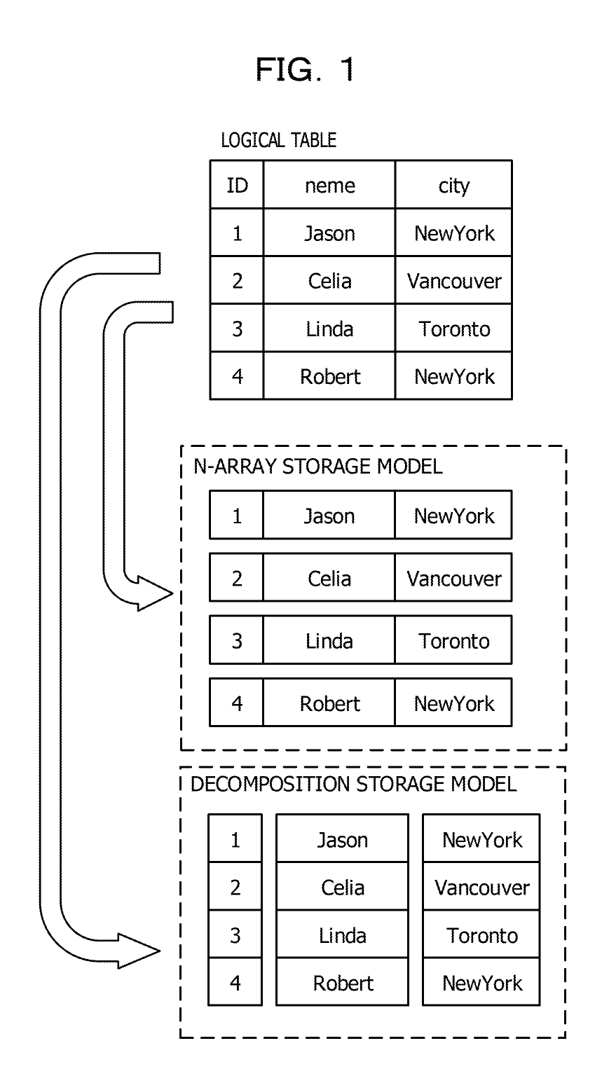

FIG. 1 is a diagram schematically illustrating an N-array storage model and a decomposition storage model. In an example illustrated in FIG. 1, “ID”, “name”, and “city” are attributes. As illustrated in FIG. 1, a logical table is stored using an N-array storage model (NSM) or a decomposition storage model (DSM). In the N-array storage model, attributes in a record are collectively stored in one storage. In the decomposition storage model, records are divided for each attribute and stored in the storage.

In the RDBMS, the N-array storage model is usually used for data storage. In the RDBMS, performance of inserting, deleting, and updating records are important. This is because it is easier to insert, delete, and update records when data is arranged in records on the storage.

On the other hand, in business intelligence and data warehouse used for data analysis, the decomposition storage model is often used. This is because only a specific attribute in a table is often read in data analysis. A database adopting the decomposition storage model is called a column-oriented database or a columnar database. Data stored using the decomposition storage model has high compression efficiency, and a data volume is reduced after compression. Thus, input/output (I/O) during read is reduced, and the performance is improved. Therefore, the column-oriented database is usually compressed.

With the recent growing demand for the column-oriented database, various column-oriented databases have been developed. As even for a row-oriented database adopting the N-array storage model, there is an increasing number of products capable of adding a column-oriented database function as an option.

There are many compression technologies that may be applied to the decomposition storage model. For example, run-length encoding (RLE) compression, dictionary compression, and the like are used.

A table structure (names of columns and data types) in the RDBMS is called a schema. The RDBMS is a database having its schema defined before insertion of data. On the other hand, there is a database called a document-type DB, which has its schema not defined before insertion of data and into which semistructured data of JSON format, XML format, or the like may be inserted.

As for some document DBs, the data volume is reduced by using a data format realized by compressing an internal structure of a document stored using the N-array storage model. However, the compression efficiency is not sufficient compared with the column-oriented database.

Hereinafter, description is given of an example of semistructured data according to the embodiment. A document used in the following description includes JSON-format semistructured data, and processing in this embodiment may also be applied to semistructured data of XML format or the like, other than JSON format.

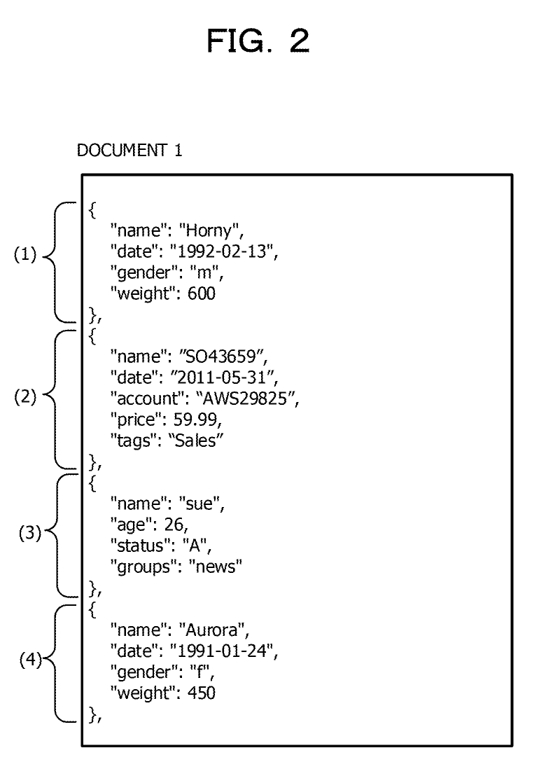

FIG. 2 is a diagram illustrating an example of a basic data type document. The basic data type document is a document including only fields of a predetermined data type and including no object or array. In the example of FIG. 2, elements in the data are described in the format of “XXXX”:“YYYY”. As for the data in this format, “XXXX” is referred to as a “field” and “YYYY” is referred to as a “field value”. A pair of the “field name” and the “field value” is referred to as a “field”. A group of data enclosed in double quotation marks and braces “{“and”}” as in the case of FIG. 2 is referred to as an “object”.

A document 1 includes four objects (1) to (4). (1) and (4) have the same structure and may be considered to be conforming to the same schema. Meanwhile, the other objects have different structures including different other fields except for the “name” field.

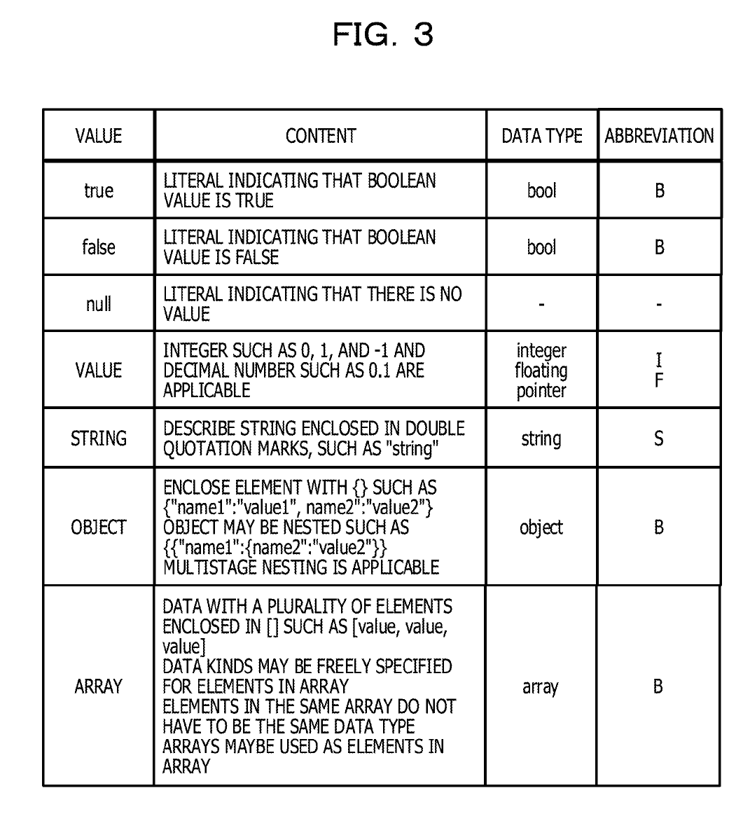

FIG. 3 is a diagram illustrating explanation of field values. FIG. 3 illustrates explanation of contents of the field values and data types in JSON, and the example illustrated in FIG. 3 is also used in this embodiment. The abbreviations are symbols defined for the description of this embodiment.

As illustrated in FIG. 3, “true” is a literal indicating that a boolean value is true, “false” is a literal indicating that the boolean value is false, “null” is a literal indicating that there is no field value.

For “value”, an integer such as 0, 1, and −1 and a decimal number such as 0.1 may be used. For “string”, a string enclosed in double quotation marks, such as “string”, may be described. “Object” is data having elements enclosed in { }, such as {“name1”:“value1”, “name2”:“value2”}. Objects may be nested, such as {{“name1”:{“name”:“value2”}}. Multistage (three stages or more) nesting is also applicable.

“Array” is data having a plurality of elements enclosed in [ ], such as [value, value, value]. Data types may be freely specified for the elements in the array. The elements in the same array do not have to have the same data type. The array may also be used as the element in the array.

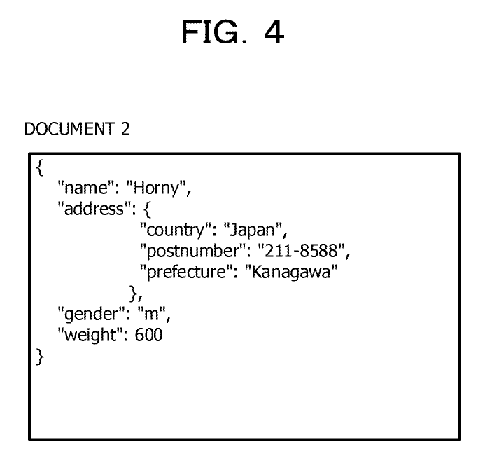

FIG. 4 is a diagram illustrating an example of a document including a nested structure of an object. As illustrated in FIG. 4, any document may include a nested structure of an object. In a document 2 illustrated in FIG. 4, the field “address” has a nested structure with subfields “country”, “postnumber”, and “prefecture”. In this embodiment, to specify the subfield, the upper field name and the lower field name are connected with “.”, such as “address.prefecture”. Although the nested structure in the document 2 has two stages, a nested structure with three stages or more may also be applied.

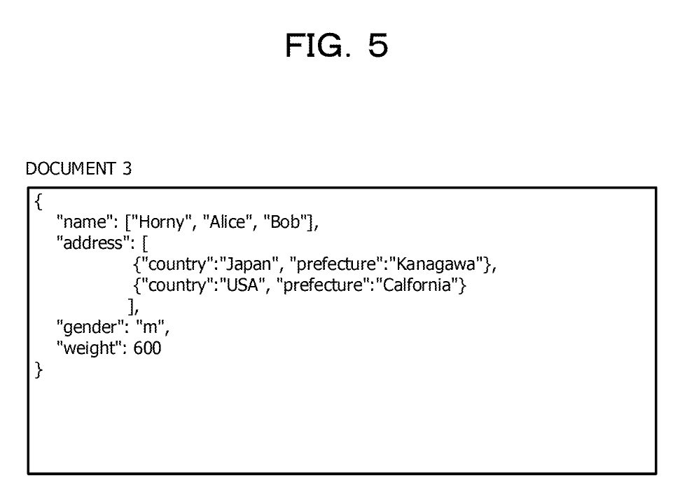

FIG. 5 is a diagram illustrating an example of a document including an array. In JSON, the array illustrated in FIG. 5 may be included in a field. An array may also be included in this embodiment. The field “name” in a document 3 is a string-type array. The field “address” is an array including an object as an element. Such an array including an object as an element may be hereinafter referred to as an object-type array.

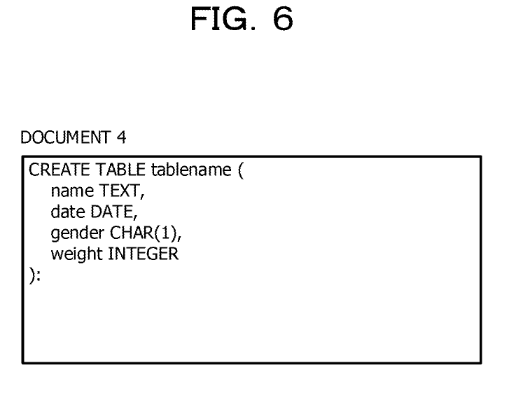

FIG. 6 is a diagram illustrating an example of field definition. The definition of each field is preset in a database, into which data in a document is inserted. In this embodiment, for example, a command of a format represented in a document 4 of FIG. 6 is used to perform field definition on the database.

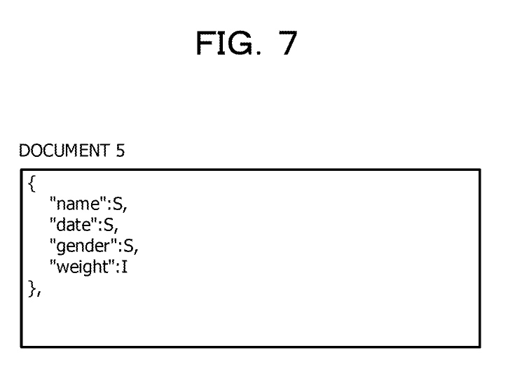

FIG. 7 is a diagram illustrating a first example of a document representing a schema. A document 5 of FIG. 7 represents the schema (1) in the document 1 illustrated in FIG. 2. The “schema” in this embodiment represents a data structure of each object, which is specified based on a combination of “field name and “data type of field value” of each field in the object. “Data type of field value” is expressed with the abbreviation illustrated in FIG. 3.

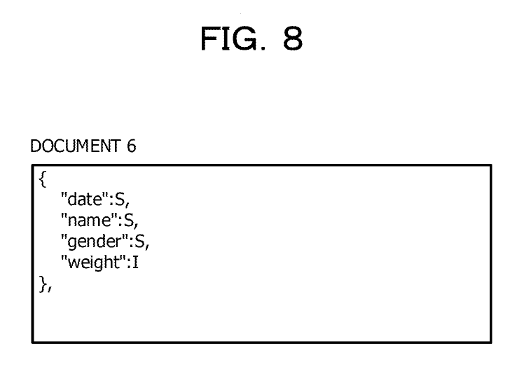

FIG. 8 is a diagram illustrating a second example of a document representing a schema. In a document 6 of FIG. 8, the order of “name”:S and “date”:S is switched compared with the document 5 of FIG. 7. In this embodiment, the schema focuses on the sorting order of the field names, and thus schemas different in sorting order are considered as different schemas even though the same field names are included therein. However, schemas including the same field names in different sorting orders may be considered as the same schema. In this embodiment, the document 6 of FIG. 8 has the schema considered to be different from that of the document 5 of FIG. 7. However, the both schemas may be considered as the same schema.

In this embodiment, schemas with different types of field values are considered as different schemas even though some of the fields in the object have the same field name. However, objects including fields with the same field name and different types of field values may be considered as the same schema.

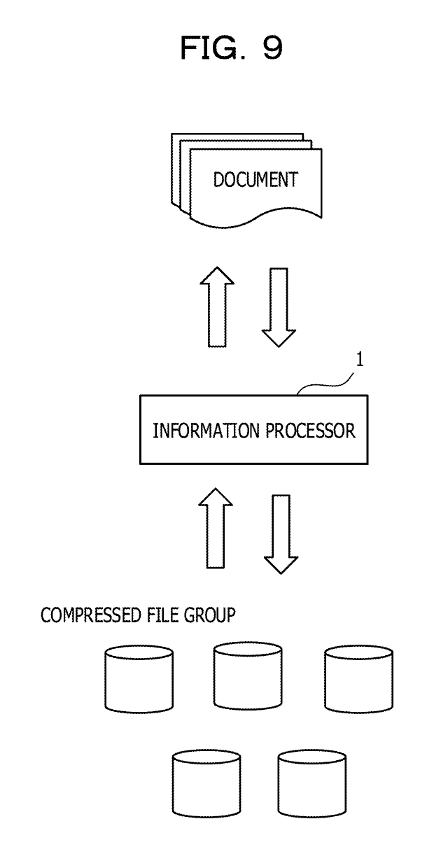

FIG. 9 is a diagram illustrating an example of a system configuration according to the embodiment. An information processor 1 of this embodiment acquires a document including semistructured data. Then, the information processor 1 stores the semistructured data divided into a plurality of files, and compresses the data for each file. The information processor 1 may restore the document by decompress the compressed file groups. The information processor 1 is, for example, a server or a personal computer. The information processor 1 is an example of a computer.

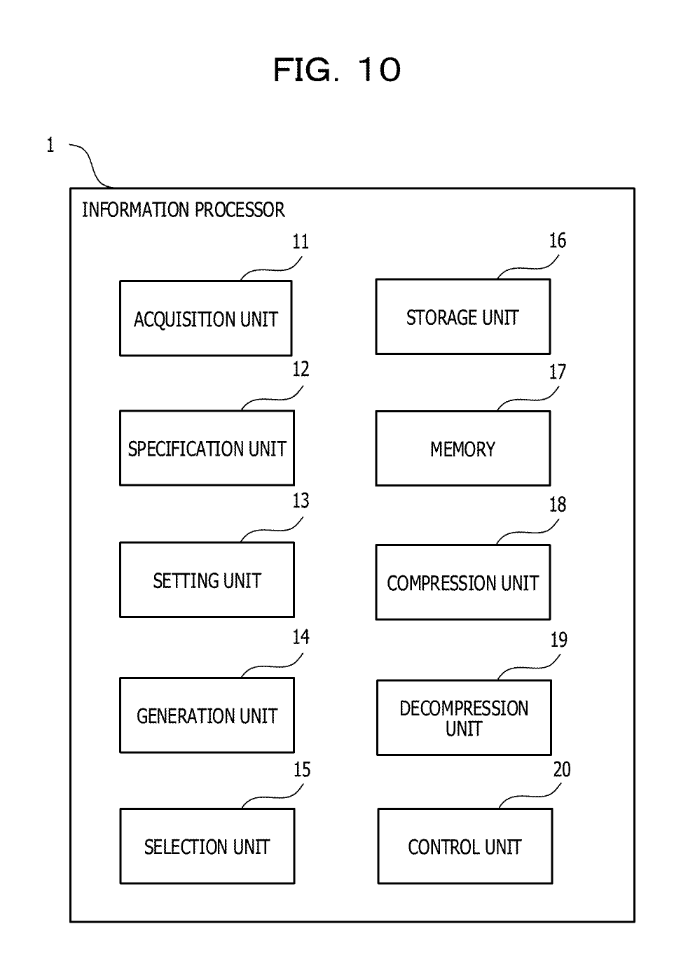

FIG. 10 is a diagram illustrating a configuration example of the information processor 1 according to the embodiment. The information processor 1 according to the embodiment includes an acquisition unit 11, a specification unit 12, a setting unit 13, a generation unit 14, a selection unit 15, a storage unit 16, a compression unit 18, a decompression unit 19, and a control unit 20.

The acquisition unit 11 acquires a document or the like including semistructured data from another information processor or the like. The specification unit 12 specifies a structure of a group included in the semistructured data, based on the kind and type of data. The kind of data is specified from the field name or field ID, for example. The group is, for example, an object.

The setting unit 13 sets a first identifier unique to each structure, and sets a second identifier for a pair of data kind and data type of each data in the structure. The structure is, for example, a schema, which is specified by a schema ID array to be described later. The first identifier is, for example, a schema ID to be described later. The second identifier is, for example, a field number to be described later.

When data (for example, the field value) is an array and elements in the array are groups, the setting unit 13 sets a first identifier different from the array for each of the groups in the array.

The generation unit 14 generates a first tree by hierarchizing the plurality of data kinds. The first tree is, for example, a field name/field ID tree to be described later. Upon acquisition of a new group, the generation unit 14 retrieves a data kind in the acquired group from the upper level of the first tree, and adds the data kind to the first tree when the data kind is not present in the first tree.

The generation unit 14 generates a second tree by hierarchizing the plurality of structures. The second tree is, for example, a field ID array/schema ID tree to be described later. Upon acquisition of a new group, the generation unit 14 retrieves a structure of the acquired group from the upper level of the second tree, and adds the structure to the second tree when the structure is not present in the second tree.

When a new document is added, the selection unit 15 selects a first identifier corresponding to a group in the document, based on a schema management table, and selects a second identifier corresponding to each data.

The storage unit 16 stores data in the group in different storage areas for each pair of a first identifier corresponding to the group and a second identifier corresponding to the data. The storage area is, for example, a file, a database, or the like. When the data is an array, the storage unit 16 stores the number of elements in the array and the elements in the array in different storage areas. When the data is an array and elements in the array are groups, the storage unit 16 stores the number of the elements in the array, a first identifier set for each of the groups in the array, and data in the group, in different storage areas.

A memory unit 17 stores the acquired documents, various trees to be described later, management information, uncompressed files, compressed files, and the like. The compression unit 18 compresses data for each storage area. The decompression unit 19 decompresses each of the compressed files to restore a document. The control unit 20 executes various control operations of the information processor 1.

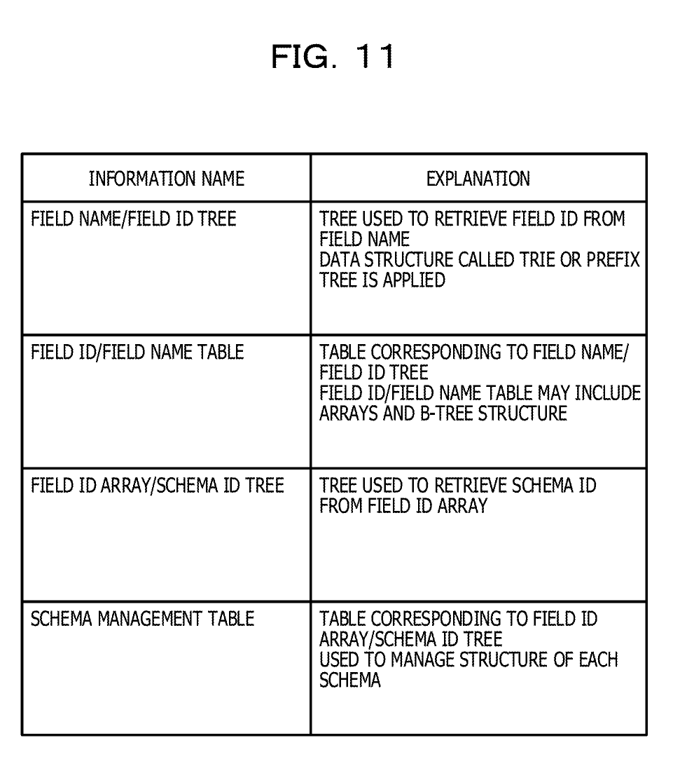

FIG. 11 is a diagram explaining information used in the embodiment. Among the information illustrated in FIG. 11, the field ID is unique identification information given to each field name in a document. The schema ID is unique identification information set for each structure of an object. For the schema ID, for example, a unique value is set for an array including a pair of the field ID and data type in the document (hereinafter referred to as the field ID array). The field ID array is an array representing the structure of the object.

The field name/field ID tree is a tree used to retrieve the field ID from the field name. For the field name/field ID tree, a data structure called a trie or a prefix tree is applied. The field ID/field name table is a table corresponding to the field name/field ID tree. The field ID/field name table may include arrays and B-tree structure.

The field ID array/schema ID tree is a tree used to retrieve the schema ID from the field ID array. The schema management table is a table corresponding to the field ID array/schema ID tree, and is used to manage the structure for each schema. The information illustrated in FIG. 11 is described in detail later.

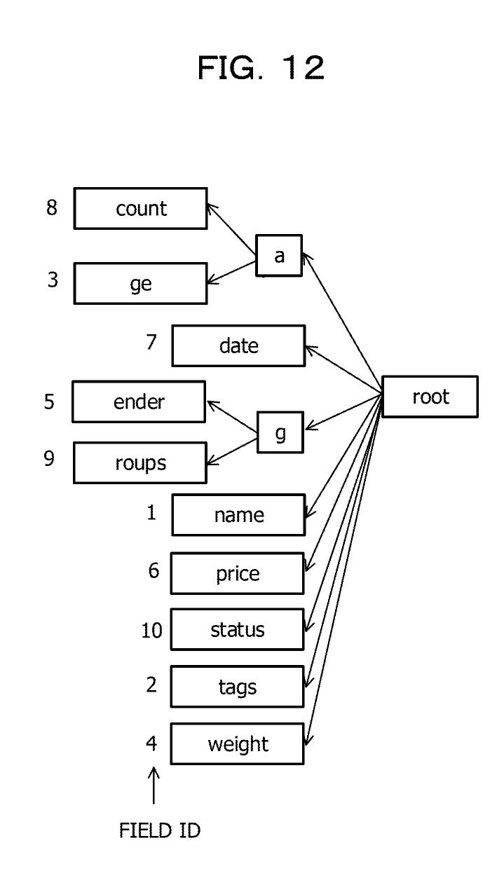

FIG. 12 is a diagram illustrating an example of the field name/field ID tree. For the tree structure of the field name/field ID tree, a data structure called a trie or a prefix tree is applied. As illustrated in the example of FIG. 12, a document includes a plurality of fields. The generation unit 14 generates a tree illustrated in FIG. 12 based on the field names in the document. When the field names have the first character in common, such as “acount” and “age” in FIG. 12, for example, the generation unit 14 sets the common strings in the upper level and the rest in the lower level. The field ID has a value set for each field name by the setting unit 13.

The generation unit 14 retrieves the field name in each field from the field name/field ID tree. When the field name/field ID tree does not include a newly acquired field name, the setting unit 13 sets a field ID corresponding to the field name. The generation unit 14 adds the field name to the field name/field ID tree, and gives the set field ID to the field name.

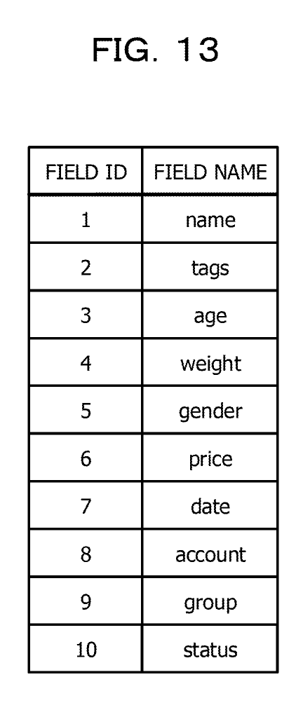

FIG. 13 is a diagram illustrating an example of the field ID/field name table. The generation unit 14 generates the field ID/field name table illustrated in FIG. 13, based on the field ID set for the field name by the setting unit 13. When adding the field name and the field ID to the field name/field ID tree, the generation unit 14 also adds the same field name and field ID to the field ID/field name table.

When a new document is added, the setting unit 13 checks if the field name/field ID tree includes a field name in the added document. If not, the setting unit 13 gives a new field ID to the field name. As for the retrieval of the field name, the retrieval may be completed more quickly by retrieval from the field name/field ID tree rather than retrieval from the field ID/field name table.

For example, while the number of items under root is 8 in the field name/field ID tree illustrated in FIG. 12, the number of records in the field ID/field name table illustrated in FIG. 13 is 10. Therefore, when a new field name is added, for example, a retrieval frequency in the case of retrieval from the field ID/field name table is 10 times, while a retrieval frequency in the case of retrieval from the field name/field ID tree is 8 times.

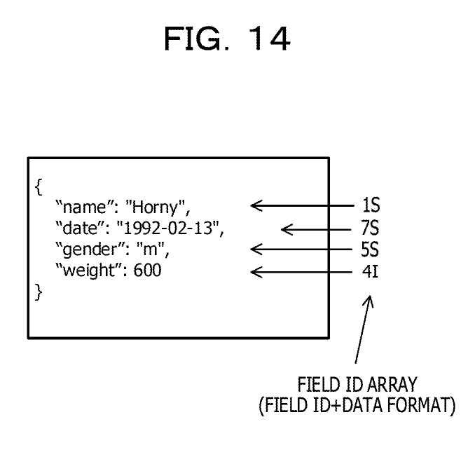

FIG. 14 is a diagram illustrating an example of the field ID array. FIG. 14 illustrates an example where a field ID array is added to (1) in the document 1 illustrated in FIG. 2. As described above, the field ID array is an array including a pair of the field ID and data type in the document. In this embodiment, as illustrated in FIG. 14, the field ID array is expressed by a pair of the field ID and the abbreviation of the data type.

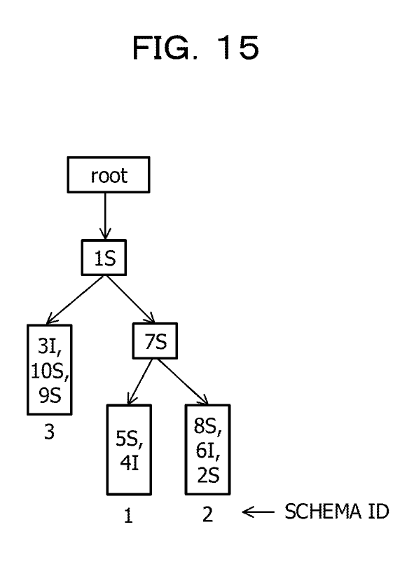

FIG. 15 is a diagram illustrating an example of the field ID array/schema ID tree. The field ID array/schema ID tree of FIG. 15 corresponds to the document 1 of FIG. 2. As illustrated in FIG. 15, the generation unit 14 generates a field ID array/schema ID tree in which fields common in schema ID arrays are set in the upper level and non-common fields are set in the lower level.

For example, since the “name” field is common in all the objects in the document illustrated in FIG. 2, “1S” representing the “name” field is set in the top level. Then, “7S” representing the “date” field common in (1), (2), and (4) is set under “1S”. Likewise, “3I”, “10S”, and “9S” representing the objects in (3) without the “date” field are set under “1S”. “5S” and “4I” representing the “gender” field and the “weight” field in (1) and (4) are set under “7S”. Likewise, “8S”, “6I”, and “2S” representing the “account” field, the “price” field, and the “tags” field in (2) are set under “7S”.

The setting unit 13 sets a unique schema ID for the schema ID array. The setting unit 13 sets a unique schema ID for each structure of an object. The generation unit 14 attaches the schema ID to the end of the tree. Since (1) and (4) have the same schema, the same schema ID (1) is attached thereto.

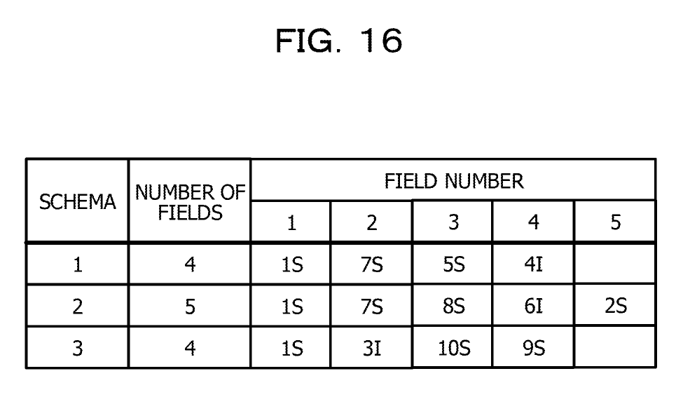

FIG. 16 is a diagram illustrating an example of a schema management table. The generation unit 14 generates the field ID array/schema ID tree, and also generates a schema management table. The setting unit 13 sets a field number for each pair (“1S”, “7S”, or the like) of the field ID (field name) and data type of each field in the structure. The schema number in the schema management table is also used as identification information on the field in the object. As the schema number, for example, the setting unit 13 uses the sorting order of the fields in the object.

As illustrated in FIG. 16, the schema management table corresponds to the field ID array/schema ID tree. The number of fields is recorded in the schema management table.

When a new document is added, the setting unit 13 checks if the field ID array/schema ID tree of FIG. 15 includes a field ID array corresponding to a structure of an object in the document. The setting unit 13 may complete retrieval more quickly by retrieving the structure of the object to be added from the field ID array/schema ID tree rather than retrieving from the schema management table.

For example, description is given of retrieval processing when the schema management table does not include the structure of the object to be added. In the case of retrieval from the schema management table, the setting unit 13 determines that the schema management table does not include the structure of the object to be added, as a result of retrieval of each entry in the schema management table. On the other hand, in the case of retrieval from the field ID array/schema ID tree of FIG. 15, the setting unit 13 may determine that there is no corresponding field ID array if the object to be added does not include a field (“name” field) corresponding to “1S” in the top level.

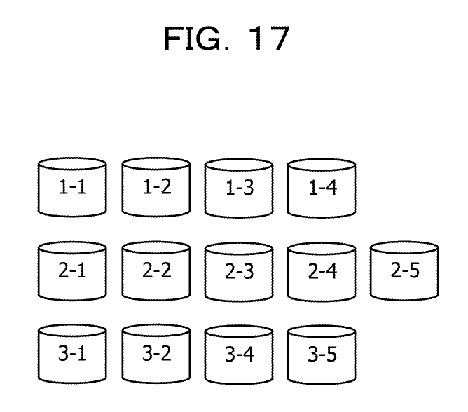

FIG. 17 is a diagram illustrating an example of files to store data. As illustrated in FIG. 17, the storage unit 16 generates a file for each pair of schema ID and field number in the schema management table. The storage unit 16 gives a file name in the form of “schema ID-field number” to each file, for example. Although files are used as data storage areas in this embodiment, databases or the like may be used.

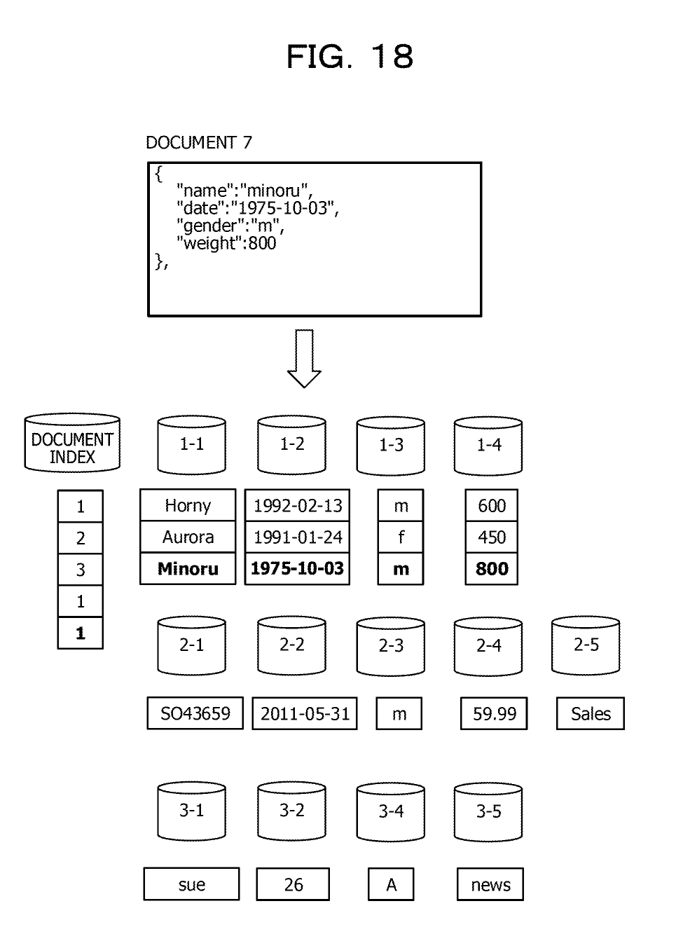

FIG. 18 is a diagram illustrating an example of a data storage method. FIG. 18 illustrates an example where the data in the document 1 of FIG. 2 is stored in the respective files generated in FIG. 17, and a document 7 is further added.

The storage unit 16 stores the data in the generated files. In the example illustrated in FIG. 18, the storage unit 16 stores field values in the objects corresponding to the schema ID “1” in the files “1-1”, “1-2”, “1-3”, and “1-4”. Since (1) and (4) in the document 1 correspond to the schema ID “1”, the storage unit 16 stores the field values of the respective fields in (1) and (4) in the files “1-1”, “1-2”, “1-3”, and “1-4”. Likewise, the storage unit 16 stores the field values in (2) corresponding to the schema ID “2” in the document 1 in files “2-1”, “2-2”, “2-3”, “2-4”, and “2-5”. Likewise, the storage unit 16 stores the field values in (3) corresponding to the schema ID “3” in the document 1 in files “3-1”, “3-2”, “3-3”, and “3-4”.

It is also assumed that the document 7 is added after the data in the document 1 is stored. The selection unit 15 selects the schema ID corresponding to the object in the document 7, based on the schema management table, and selects the field number corresponding to each field. In the example illustrated in FIG. 18, the structure of the object in the document 7 corresponds to the structure of the schema ID “1”. Therefore, the storage unit 16 stores the respective field values in the document 7 in the files “1-1”, “1-2”, “1-3”, and “1-4”.

The storage unit 16 also stores the schema IDs of the stored data as a document index in the order of data storage.

The compression unit 18 compresses the files having the data stored therein, for each file. As described above, the file is generated for each pair of field name and data type. Therefore, since each data stored in one file has a common data type, the information processor 1 according to the embodiment may improve compression efficiency.

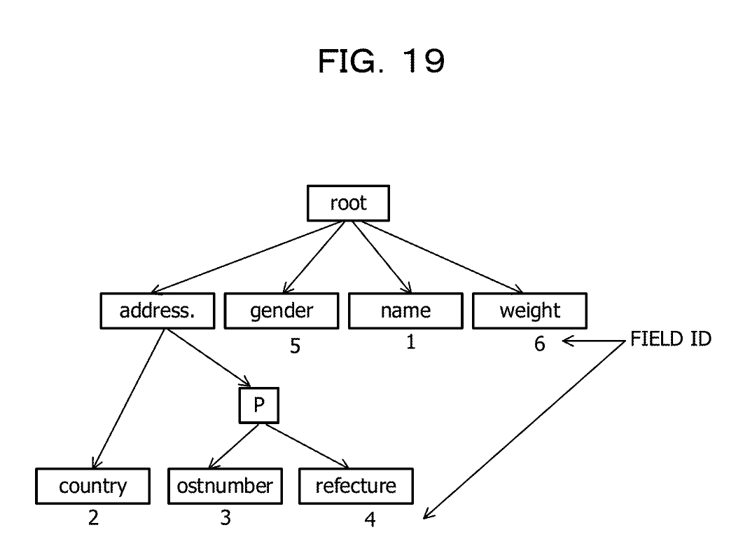

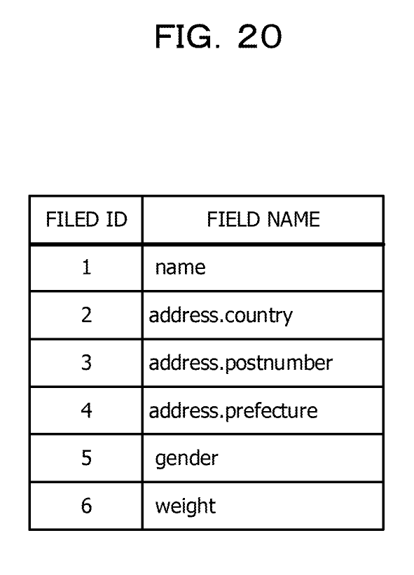

FIG. 19 is a diagram illustrating an example of a field name/field ID tree of a document with a nested object. FIG. 20 is a diagram illustrating an example of a field ID/field name table of a document with a nested object.

When there is a nested object as in the case of the document 2 of FIG. 4, the generation unit 14 expresses a field name by connecting the upper field name and the lower field name with “.”. The generation unit 14 generates a field name/field ID tree and a field ID/field name table by using the field name connected with “.”.

For example, the generation unit 14 expresses the fields in the “address” field in the document 2 of FIG. 4 as “address.country”, “address.postnumber”, and “address.prefecture”. As a result, the generation unit 14 generates the field name/field ID tree illustrated in FIG. 19 and the field ID/field name table illustrated in FIG. 20 for the document 2 of FIG. 4.

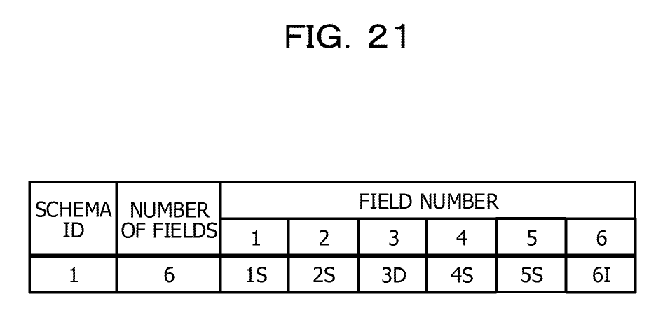

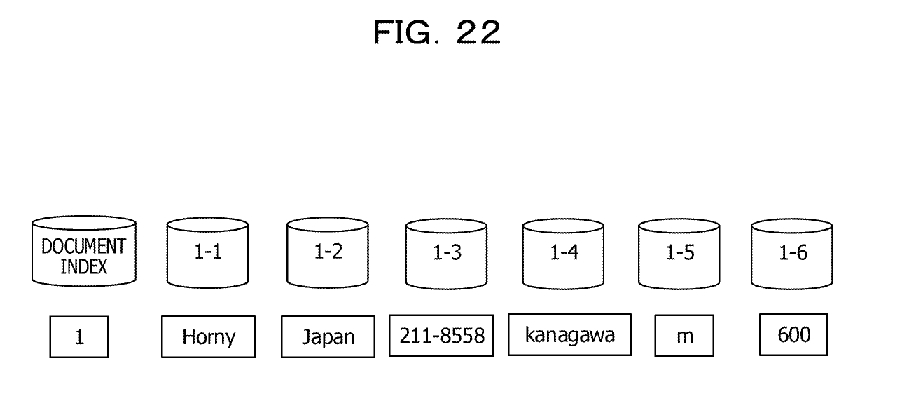

FIG. 21 is a diagram illustrating an example of a schema management table of a document with a nested object. FIG. 22 is a diagram illustrating an example of a data storage method for a document with a nested object.

As described above, when there is a nested object, the field ID is given for each field in the lower object. Therefore, in the schema management table, the field number is also given for each field in the lower object. As a result, as illustrated in FIG. 22, the fields in the lower object are also stored in different files for each field value.

Next, description is given of processing when there is an array in semistructured data. An array included in the semistructured data is classified into the following (A) to (C).

(A) All elements in an array are standardized as a basic data type, including boolean value, string, integer, floating point, and the like. Such an array is referred to as a basic data type array.

(B) All elements in an array are objects. The objects of the respective elements may have different schemas. Such an array is referred to as an object type array.

(C) An array other than (A) and (B). For example, an array in which elements have different data types or a basic data type is mixed with objects.

Since the processing of this embodiment is not applicable to arrays corresponding to (C), description is given of processing for the arrays of (A) and (B).

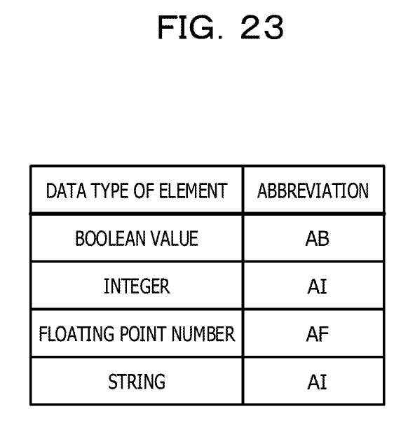

FIG. 23 is a diagram illustrating an example of abbreviations of data types of an array. When semistructured data includes an array, abbreviations illustrated in FIG. 23 are applied, in addition to the abbreviations illustrated in FIG. 3. As illustrated in FIG. 23, the data type of the array takes the form with “A” attached before the data type of the element in the array.

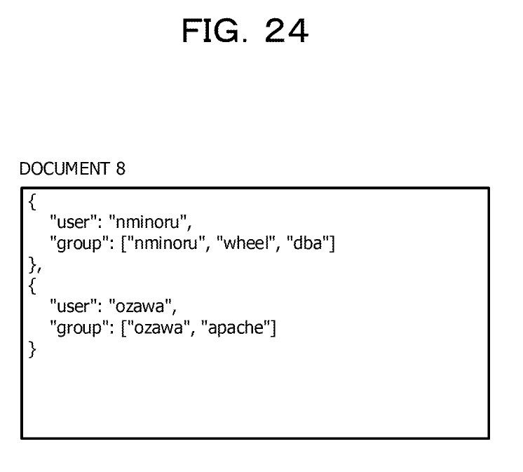

FIG. 24 is a diagram illustrating an example of a document including a basic data type array. A document 8 illustrated in FIG. 24 includes two arrays “group”. Since all elements in both of the arrays “group” are string type, the both arrays correspond to the basic data type array.

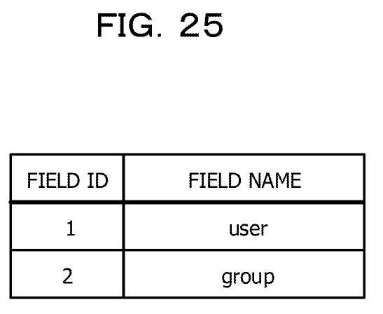

FIG. 25 is a diagram illustrating an example of a field ID/field name table of a document including a basic data type array. The table illustrated in FIG. 25 is a field ID/field name table generated based on the document 8 of FIG. 24.

Since the document 8 includes two kinds of field names, “user” and array “group”, the setting unit 13 sets a field ID for each of the field names. The generation unit 14 uses the field IDs set by the setting unit 13 to generate a field ID/field name table.

Although the generation unit 14 generates a field name/field ID tree and a field ID array/schema ID tree for the document including the basic data type array, illustration thereof is omitted.

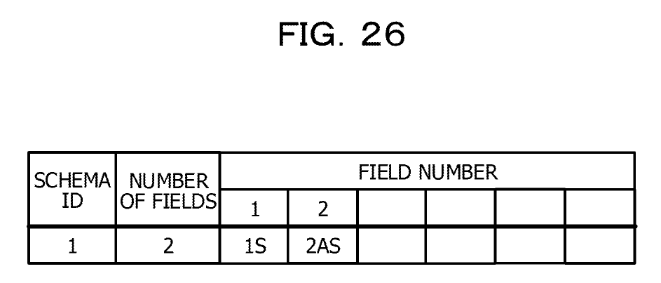

FIG. 26 is a diagram illustrating an example of a schema management table of a document including a basic data type array. The document 8 of FIG. 24 includes two objects, both of which have a structure in common, including two fields “user” and “group”. Therefore, the setting unit 13 sets one schema ID corresponding to the two objects. Although the two arrays “group” are different in the number of elements, the setting unit 13 considers that the two objects have the same structure since all the elements are the same data type (string).

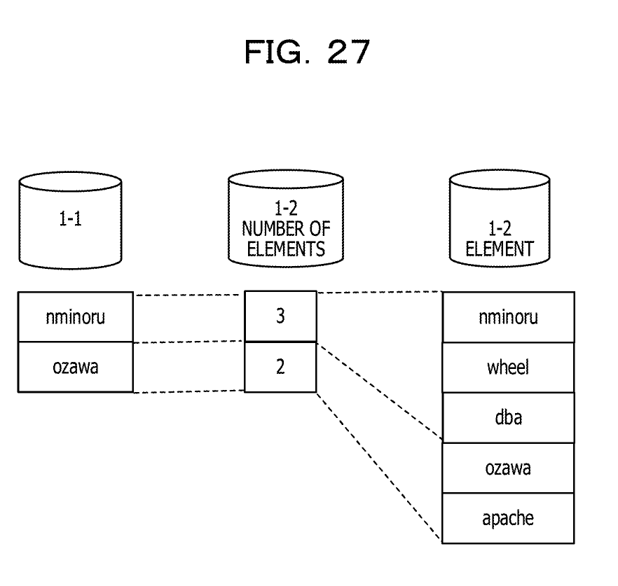

FIG. 27 is a diagram illustrating an example of a data storage method for a document including a basic data type array. As illustrated in FIG. 26, a field corresponding to the schema ID “1” and the field number “2” is an array. When the field is the array, the storage unit 16 stores the number of elements in the array and the elements in the array in different files.

Since the first array “group” in the document 8 of FIG. 24 includes three elements, the storage unit 16 stores “3” in the file “1-2 Number of Elements”. Since the second array “group” in the document 8 of FIG. 24 includes two elements, the storage unit 16 stores “2” in the file “1-2 Number of Elements”.

Since the first array “group” in the document 8 of FIG. 24 includes field values “nminoru”, “wheel”, and “dba” as elements, the storage unit 16 stores the respective field values in the file “1-2 Element”. Since the second array “group” in the document 8 of FIG. 24 includes two field values “ozawa” and “apache” as elements, the storage unit 16 stores the respective field values in the file “1-2 Element”.

As illustrated in FIG. 27, when the field is an array, the storage unit 16 stores the number of elements in the array and the elements in the array in different files. Thus, even when the field is the array, data may be stored in a column format. Since the description is given of a case where all the elements in the array are the same data type in this embodiment, the field values in the file have the same data type. Since the number of elements is an integer, the data type is the same in the file that stores the number of elements. Therefore, the information processor 1 may improve the compression efficiency of the semistructured data including the array.

Since the storage unit 16 stores the number of elements in the array and the elements in the array in different files, the arrays different in the number of elements may be handled as one schema. Thus, the number of files may be reduced.

Next, description is given of processing when an array in a document includes objects as elements. Although a plurality of objects in the array have different schemas in the following example, the same processing is applicable even when the plurality of objects in the array have the same schema.

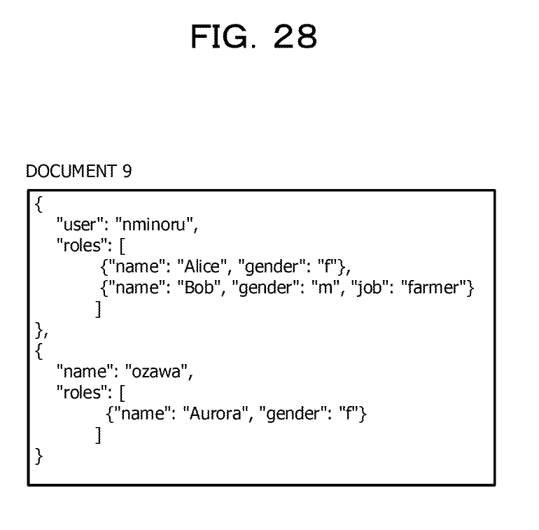

FIG. 28 is a diagram illustrating an example of a document including an object type array. In the example illustrated in FIG. 28, an array “roles” is an array including objects as elements. A document 9 includes two arrays “roles”, which are different in the number of elements.

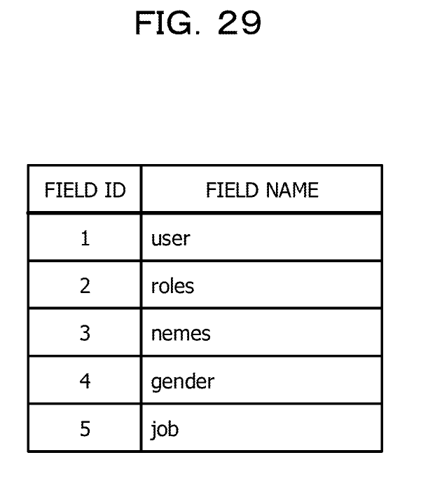

FIG. 29 is a diagram illustrating an example of a field ID/field name table of the document including the object type array. “roles” illustrated in FIG. 29 is a field name of the array, and “name”, “gender”, and “job” are field names included in the object in the array. The setting unit 13 sets different field IDs for the field name of the array and the field names included in the objects in the array.

Although the document 9 includes two arrays “roles”, which are different in the number of elements, the same field ID is given thereto.

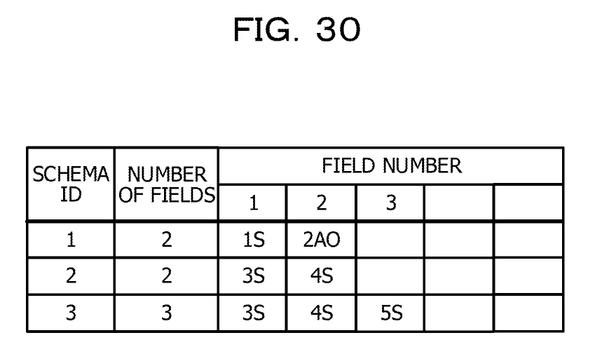

FIG. 30 is a diagram illustrating an example of a schema management table of the document including the object type array. “2AO” illustrated in FIG. 30 represents the object type array “roles”. The setting unit 13 sets “AO” as the data type of the object type array, regardless of the number of fields in the object and the data types of the fields.

In FIG. 30, the schema ID “1” represents a structure including the basic data type “user” and the array “roles”. The schema IDs “2” and “3” represent structures of the objects in the array “roles”.

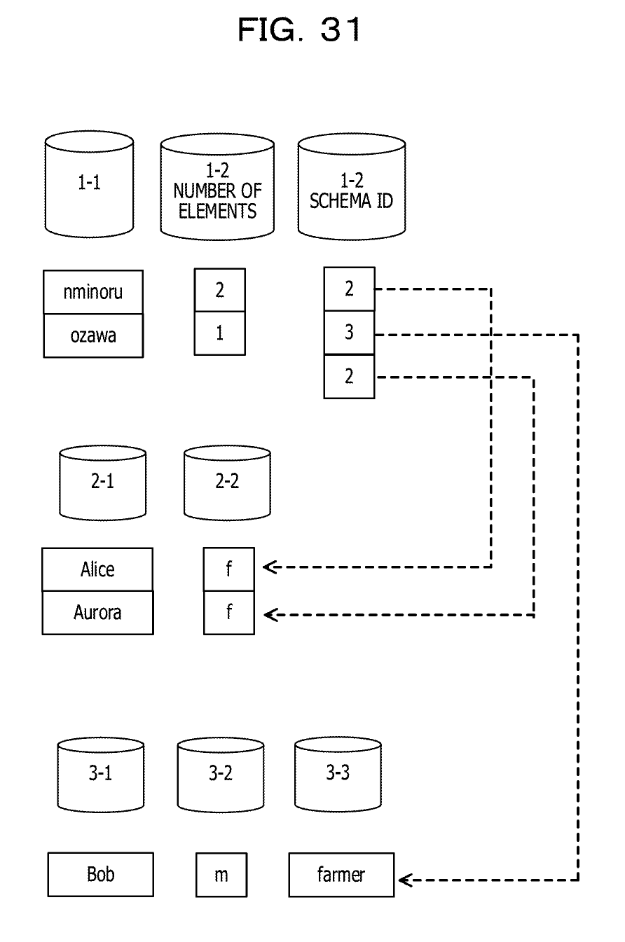

FIG. 31 is a diagram illustrating an example of a data storage method for the document including the object type array. As for the object type array, the storage unit 16 stores the number of elements in the array, the schema IDs set for the objects in the array, and the field values in the object, in different files.

In the example illustrated in FIG. 31, the number of elements in the first array “roles” is 2, and the number of elements in the second array “roles” is 1. Therefore, the storage unit 16 stores “2” and “1” in the file “1-2 Number of Elements”. Since the schema IDs set for the two objects in the first array “roles” are “2” and “3”, the storage unit 16 stores “2” and “3” in the file “1-2 Schema ID”. Since the schema ID set for the object in the second array “roles” is “2”, the storage unit 16 stores “2” in the file “1-2 Schema ID”.

As in the case of the basic data type data, the storage unit 16 stores the objects in the array in different files for each pair of the schema ID and the field number in the schema management table. In the example illustrated in FIG. 31, the storage unit 16 stores the objects in the array in “2-1”, “2-2”, “3-1”, “3-2”, and “3-3”.

For example, when a document includes a plurality of arrays having different schemas of the objects as elements, the number of schemas may be increased if the respective arrays are considered as different structures. In this embodiment, arrays having different schemas of the objects as elements are considered as the same schema, and the schema IDs are set for the objects in the array. Thus, an increase in the number of schemas may be avoided.

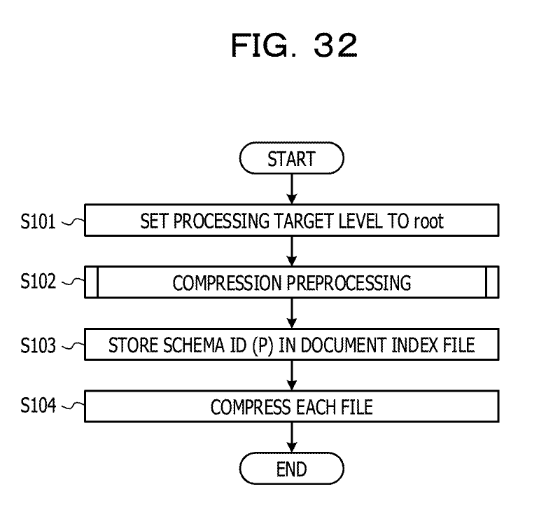

FIG. 32 is a flowchart illustrating an example of a processing flow according to the embodiment. The control unit 20 sets a processing target level to root in a processing target document (Step S101). The processing target level represents a level when the document includes multiple levels of data, and root represents the top level.

The information processor 1 executes compression preprocessing (Step S102). The compression preprocessing is described in detail later. The storage unit 16 stores a schema ID (P) in a document index file (Step S103). The compression unit 18 compresses data for each file (Step S104).

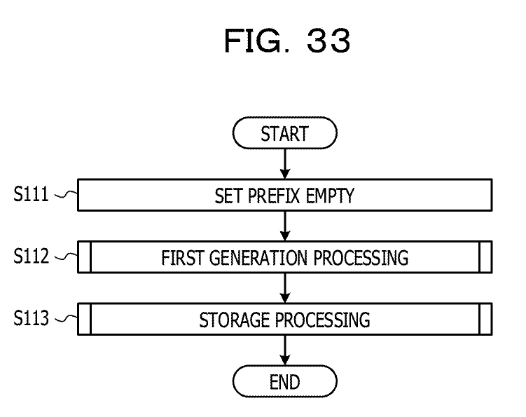

FIG. 33 is a flowchart illustrating an example of the compression preprocessing. The control unit 20 sets a prefix empty (Step S111). The prefix is used to hold a field name in processing to be described later. The generation unit 14 executes first generation processing (Step S112). The first generation processing is processing of generating a field ID array/schema ID tree and a schema management table, and is described in detail later. The storage unit 16 executes storage processing (Step S113). The storage processing is described in detail later.

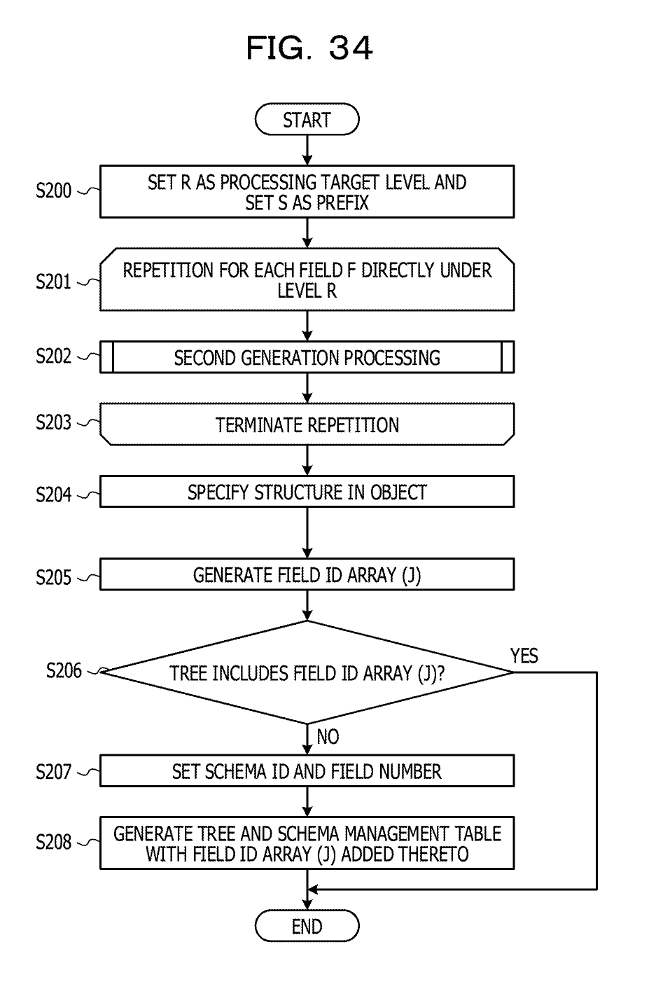

FIG. 34 is a flowchart illustrating an example of the first generation processing. The generation unit 14 sets the processing target level to R, and sets the prefix to S (Step S200). When management table generation processing is called up for the first time, root is set in R and empty is set in S.

The generation unit 14 starts repetition processing for each field F directly under the level R (Step S201). When the document 2 of FIG. 4 is used, the field F directly under the level R represents “name”, “address”, “gender”, and “weight” if R is root, and represents “country”, “postnumber”, and “prefecture” if R is “address”.

The generation unit 14 executes second generation processing for the field F (Step S202). The second generation processing is processing of generating a field name/field ID tree and a field ID/field name table. Upon completion of the processing in Step S202 for each field F, the generation unit 14 terminates the repetition processing (Step S203).

The specification unit 12 specifies an object structure based on a combination of the field name and the data type in the object (Step S204).

The generation unit 14 uses the generated field name/field ID tree and field ID/field name table to generate a field ID array, and sets the generated field ID array as J (Step S205).

The generation unit 14 determines whether or not the field ID array/schema ID tree includes the generated field ID array (J) (Step S206). When the generation unit 14 determines that there is no field ID array (J) (NO in Step S206), the setting unit 13 sets a schema ID for the field ID array (J) and sets a field number for a pair of the field name and the data type of each data in the object (Step S207). As described above, the field ID array (J) is an array representing the structure of the object.

The generation unit 14 generates a field ID array/schema ID tree and a schema management table, to which the field ID array (J) is added (Step S208). When determining that there is the field ID array (J) (YES in Step S206), the generation unit 14 terminates the processing.

Since no field ID array/schema ID tree is generated in the first round of processing, the generation unit 14 skips Step S206 and executes Steps S207 and S208.

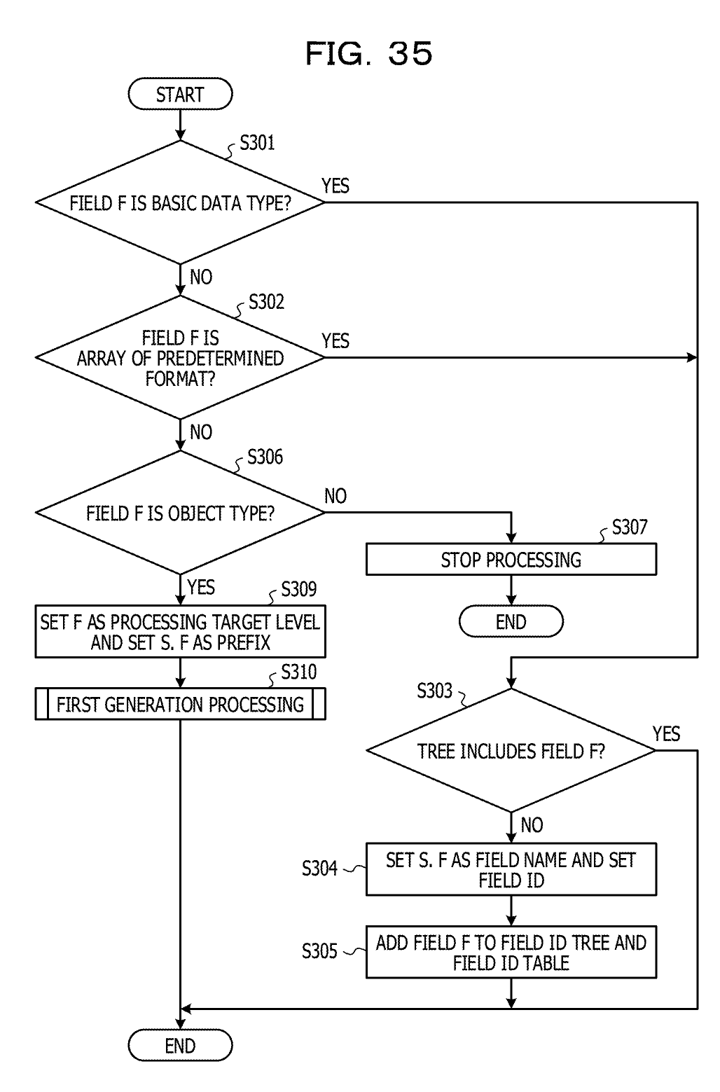

FIG. 35 is a flowchart illustrating an example of the second generation processing. It is determined whether or not the field F is a basic data type (Step S301). When the field F is not the basic data type (NO in Step S301), it is determined whether or not the field F is a predetermined type of array (Step S302). The predetermined type of array is the basic data type array or object type array described above.

If YES in Step S301 or Step S302, it is checked if the field name/field ID tree includes the field name of the field F (Step S303). When the field name/field ID tree does not include the field name (NO in Step S303), the setting unit 13 sets “field name of S. F” as the field name, and sets the field ID corresponding to the field name (Step S304). When Step S304 is called up for the first time, the setting unit 13 sets the field name of the field F without change since S is empty.

Then, the generation unit 14 adds the field name and the field ID set for the field F to the field name/field ID tree and the field ID/field name table (Step S305).

When the field name/field ID tree includes the field name of the field F (YES in Step S303), the processing is terminated.

If NO in Step S302, it is determined whether or not the field F is the object type (Step S306). When the field F is not the object type (NO in Step S306), the information processor 1 stops the processing since the data is not the processing target data (Step S307).

When the field F is the object type (YES in Step S306), the setting unit 13 sets F as the processing target level and sets “field name of S. F” as the prefix (Step S309). Then, the generation unit 14 recursively calls up the first generation processing (Step S310).

When there is a nested object as illustrated in FIGS. 19 and 20, the field name is expressed in the form of “upper field name. lower field name”. When Step S309 is called up for the first time, the field name of S. F is the field name of F since S is empty. When the second generation processing is called up again from the first generation processing in Step S310, “field name of S. F” takes the form of “upper field name. lower field name” in Step S304, since the upper field name is set for S.

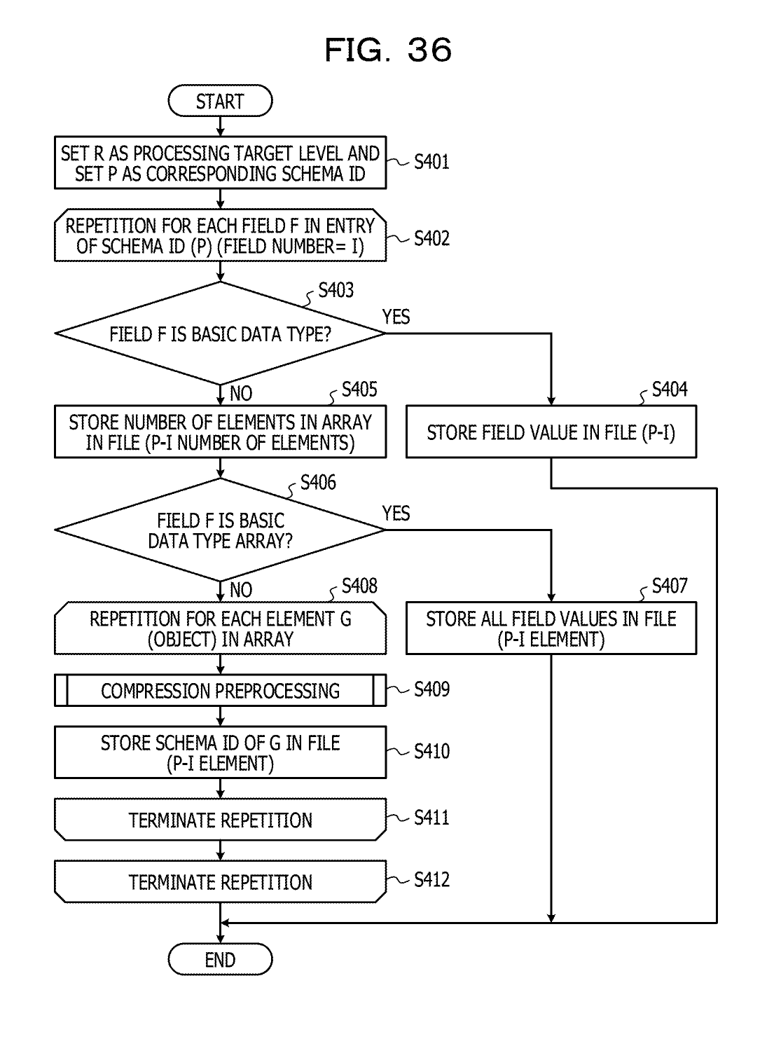

FIG. 36 is a flowchart illustrating an example of the storage processing. The storage unit 16 sets R as the processing target level and sets P as the corresponding schema ID (Step S401). In the first round of processing, the storage unit 16 sets root as R and sets the smallest value among the schema IDs yet to be stored, as the schema ID.

The storage unit 16 starts repetition processing for each field (F) corresponding to the schema ID (P) (Step S402). The field number is I. The storage unit 16 determines whether or not the field F is the basic data type (Step S403). When the field F is the basic data type (YES in Step S403), the storage unit 16 stores the field value in the file (P-I) (Step S404).

When the field F is not the basic data type (NO in Step S405), the field F is an array, and thus the storage unit 16 stores the number of elements in the array in the file (P-I Number of Elements) (Step S405). Then, the storage unit 16 determines whether or not the field F is a basic data type array (Step S406). When the field F is the basic data type array (YES in Step S406), the storage unit 16 stores all the field values of the elements in the array in the file (P-I Element) (Step S407).

When the field F is not the basic data type array (NO in Step S406), the field F is the object type array, and thus the storage unit 16 starts repetition processing for each element G (object) in the array (Step S408).

The storage unit 16 recursively calls up the compression preprocessing (Step S409). In Step S409, as for the processing target element G (object), addition to the field ID array/schema ID tree and the schema management table, and the like are performed, and storage of the fields in the object is also performed.

The storage unit 16 stores the schema ID corresponding to the object stored in Step S409 in the file (P-I Schema ID) (Step S410). Upon completion of the processing for all the elements in the array (Steps S409 and S410), the storage unit 16 terminates the repetition processing (Step S411). Upon completion of the processing for all the fields corresponding to the schema ID (P) (Steps S403 to S411), the storage unit 16 terminates the repetition processing (Step S412).

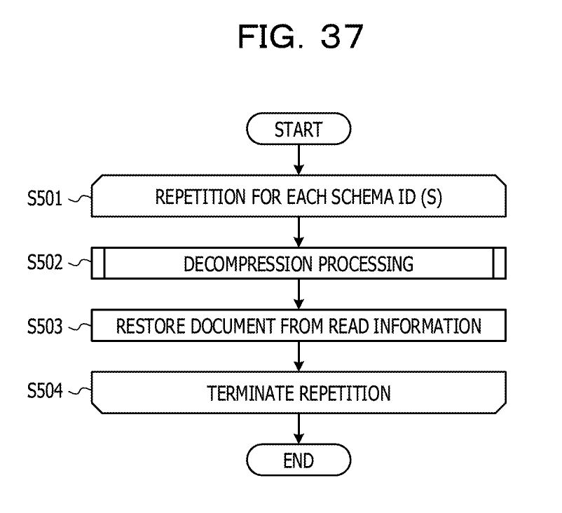

FIG. 37 is a flowchart illustrating an example of restoration processing. The decompression unit 19 starts repetition processing for each schema ID by referring to the schema management table (Step S501). The decompression unit 19 executes decompression processing of a file corresponding to the processing target schema ID (Step S502). The decompression unit 19 restores the document before compression, based on information read from the decompressed file (Step S503). The decompression unit 19 terminates the processing after executing Steps S502 and S503 for the files corresponding to all the schema IDs (Step S504).

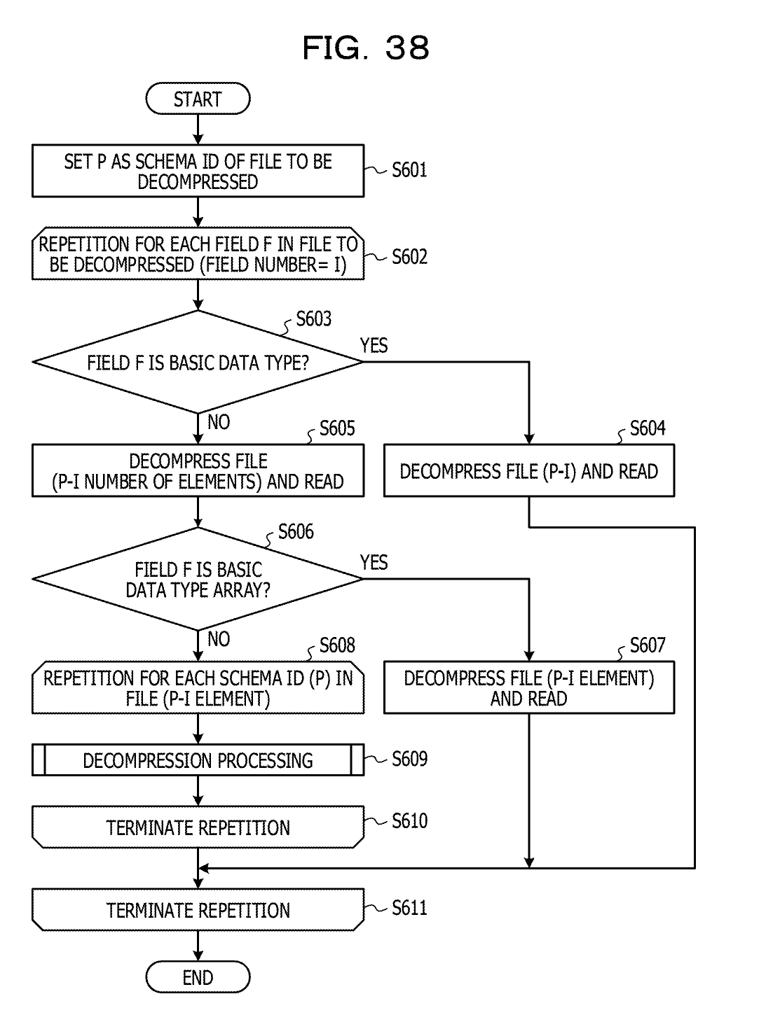

FIG. 38 is a flowchart illustrating an example of the decompression processing. The decompression unit 19 sets P as the schema ID of the file to be decompressed (Step S601). The decompression unit 19 starts repetition processing for each field F corresponding to the decompression target schema ID (Step S602). The field number is I.

The decompression unit 19 determines whether or not the field F is the basic data type (Step S603). When the field F is the basic data type (YES in Step S603), the decompression unit 19 decompresses the file (P-I) and reads data in the file (Step S604). When the field F is not the basic data type (NO in Step S603), that is, is an array, the decompression unit 19 decompresses the file (P-I Number of Elements) and reads data in the file (Step S605).

The decompression unit 19 determines whether or not the field F is the basic data type array (Step S606). When the field F is the basic data type array (YES in Step S606), the decompression unit 19 decompresses the file (P-I Element) and reads data from the decompressed file (Step S607).

When the field F is not the basic data type array (NO in Step S606), the field F is the object type array. In the object type array, the schema ID of each object in the array is stored in the file (P-I Element). Therefore, the decompression unit 19 starts repetition processing for each schema ID (P) in the file (P-I Element) (Step S608).

The decompression unit 19 recursively calls up the decompression processing with the schema ID in the file (P-I Element) as the processing target (Step S609). When the field in the object is the basic data type, the decompression unit 19 decompresses the file (P-I) in which the field value in the object is stored by the processing in Step S604, and reads data.

The decompression unit 19 terminates the repetition processing after executing Step S609 for all the schema IDs in the file (P-I Element) (Step S610). The decompression unit 19 terminates the repetition processing after executing Steps S603 to S610 for all the fields (Step S611).

### EXAMPLE

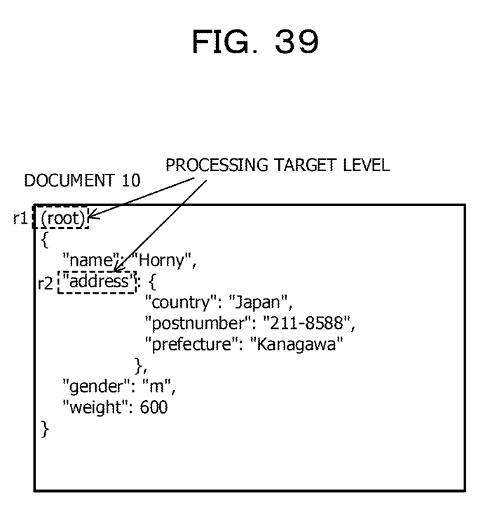

FIG. 39 is a diagram illustrating a first example of a document to be applied to the processing of the embodiment. A document 10 illustrated in FIG. 39 includes the basic data type fields “name”, “gender”, and “weight” as well as the object type field “address”. In the document 10 illustrated in FIGS. 39, r1 and r2 represents processing target levels.

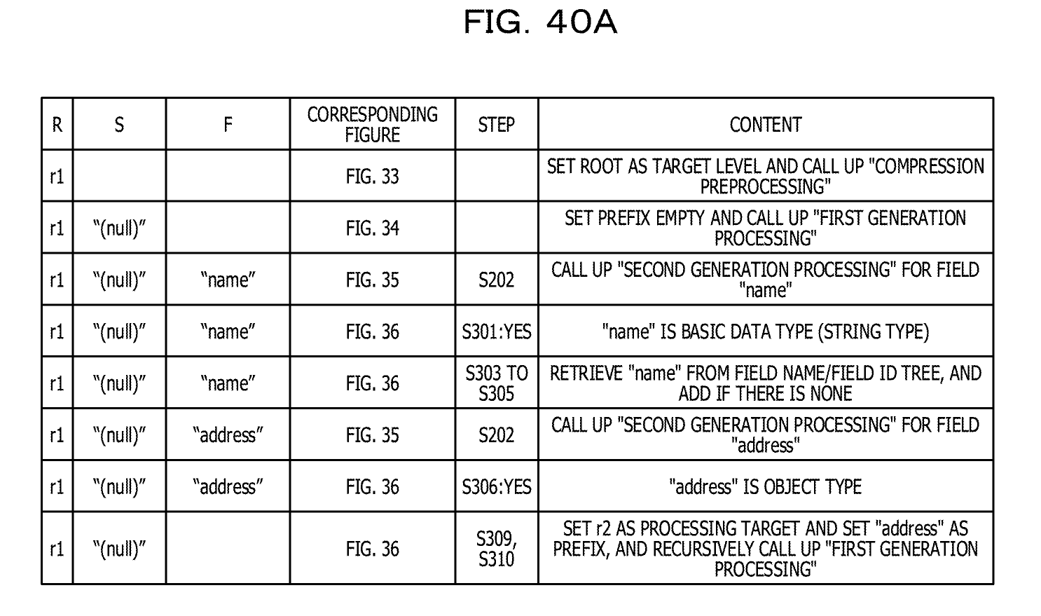

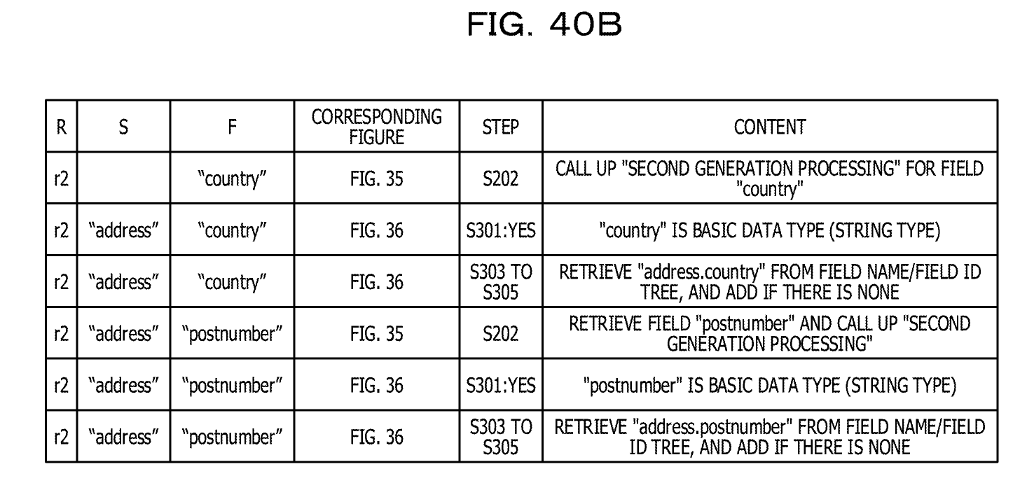

FIG. 40 (i.e., FIGS. 40A and 40B) is a diagram illustrating a processing example when the processing of the embodiment is performed on the document 10. The processing illustrated in FIG. 40 is not all the processing for the document 10, and some of the processing is omitted.

As illustrated in FIG. 40, as for the field “name”, various kinds of processing such as addition to the field name/field ID tree is performed by executing the first generation processing and the second generation processing in a state where the prefix is empty. Since the field “address” is the object type, the first generation processing and the second generation processing are performed in a state where “address” is set as the prefix, thereby connecting “address” and the lower fields “country” and “postnumber” to be recorded as the field name.

Even when there is the object type field, the information processor 1 may record the field name having the upper and lower field names connected by performing recursive processing in a state where the upper field name is stored.

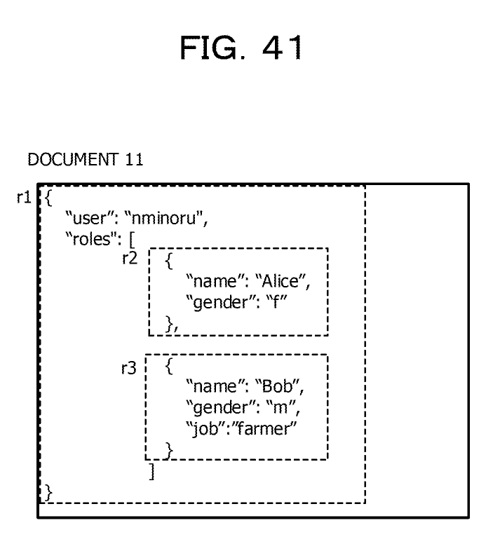

FIG. 41 is a diagram illustrating a second example of a document to be applied to the processing of the embodiment. In a document 11 illustrated in FIG. 41, r1, r2, and r3 represent processing target levels. The document 11 includes the basic data type field “user” and the object type array “roles”. Different levels are set for respective objects in the array.

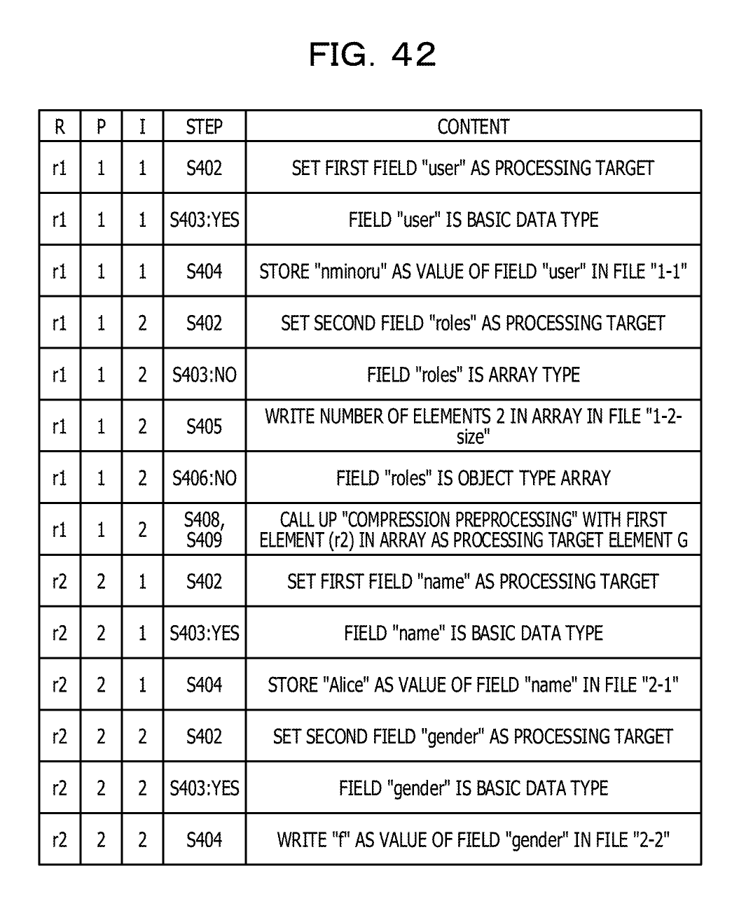

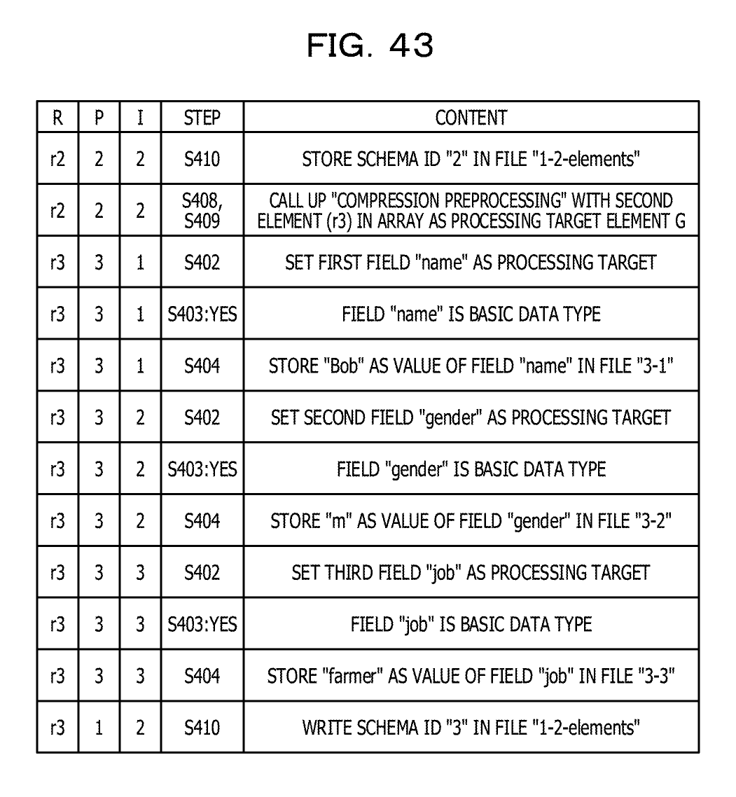

FIGS. 42 and 43 are diagrams illustrating a storage processing example when the storage processing of the embodiment is performed on the document 11. The processing illustrated in FIGS. 42 and 43 is not all the processing for the document 11, and some of the processing is omitted. As illustrated in FIGS. 42 and 43, the storage unit 16 stores the field value without change in the file, since the field “user” is the basic data type.

Since the field “roles” is an array, the storage unit 16 stores the number of elements “2” in the array in the file. Then, the storage unit 16 calls up the first generation processing and the second generation processing by calling up the compression preprocessing for the elements in the array, thereby adding the fields in r2 to the field name/field ID tree and the schema management table. Thereafter, in the storage processing recursively called up, the storage unit 16 stores the field values of the elements “name” and “gender” in the object in the file. The storage unit 16 also stores the fields in r2 in the file.

As described above, the information processor 1 may store the elements in the object type array in the files.

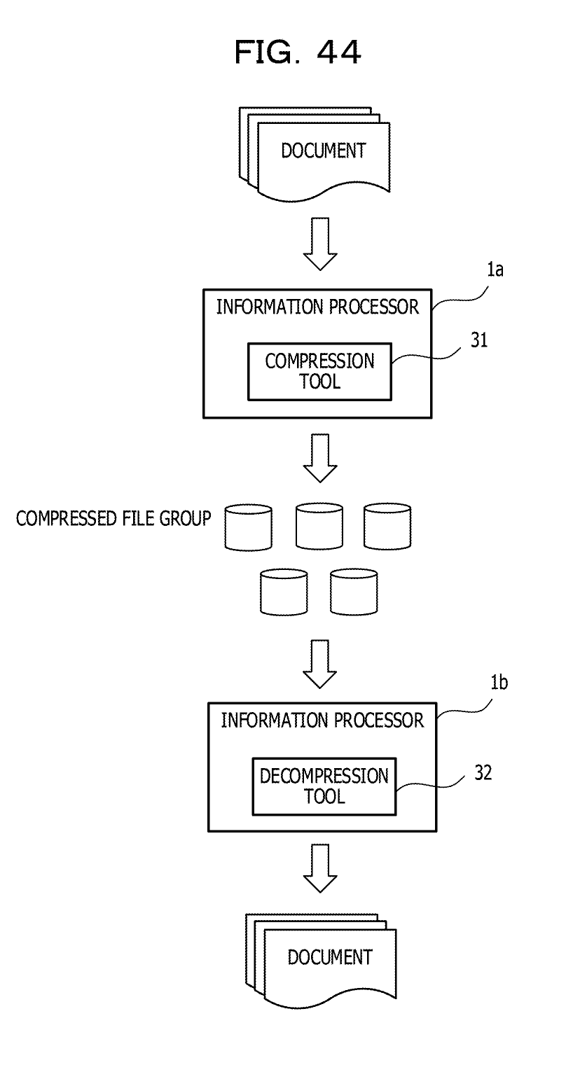

FIG. 44 is a diagram illustrating a first example of a system configuration. The system configuration illustrated in FIG. 44 includes an information processor la and an information processor lb, which correspond to the information processor 1 in the embodiment.

The information processor 1a includes a compression tool 31 with the functions of the information processor 1 of the embodiment. The information processor 1a acquires a document including semistructured data. Then, the compression tool 31 performs the processing described above to store the semistructured data in a plurality of files, and compresses each of the files. The information processor 1a transmits the compressed file group to the information processor 1b.

The information processor 1b includes a decompression tool 32 with the functions of the information processor 1 of the embodiment. The information processor 1b acquires the compressed file group. Then, the decompression tool 32 performs the processing described above to decompress the compressed file group and restore the document.

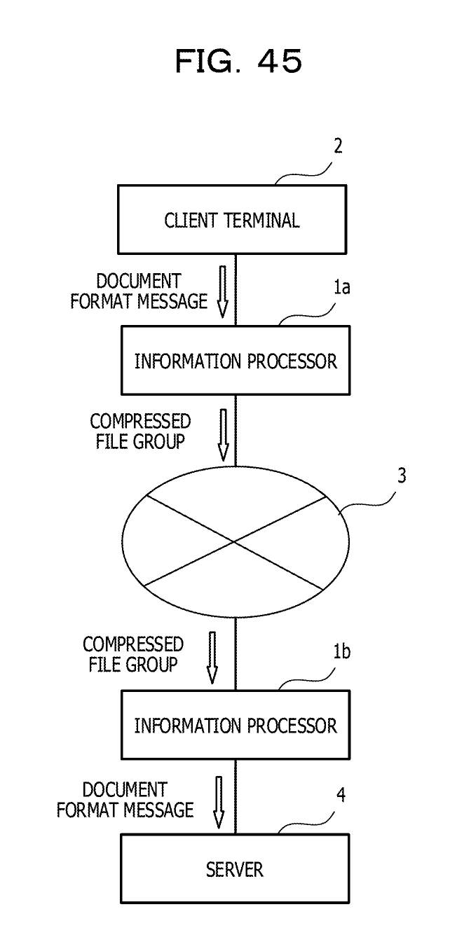

FIG. 45 is a diagram illustrating a second example of a system configuration. In the second example, compression is performed to transmit and receive a document format message through a network. The system configuration of the second example includes a client terminal 2, the information processor la, a network 3, the information processor 1b, and a server 4.

The client terminal 2 transmits, to the information processor 1a, a document format message including semistructured data addressed to the server 4. The information processor 1a acquires the document format message. Then, the information processor 1a performs the processing described above to store the document format message in a plurality of files, and compresses each of the files. The information processor la transmits the compressed file group to the information processor 1b through the network 3.

The information processor 1b acquires the transmitted compressed file group. Then, the information processor 1b performs the processing described above to decompress the compressed file group and restore the document format message. The information processor 1b transmits the restored document format message to the server 4.

When the client terminal 2 continuously transmits messages, the information processor la performs storage and compression after receiving a predetermined number of document format messages, for example. The information processor 1b transmits the received document format messages to the server 4 after sequentially decompressing the messages.

<Hardware Configuration of Information Processor 1>

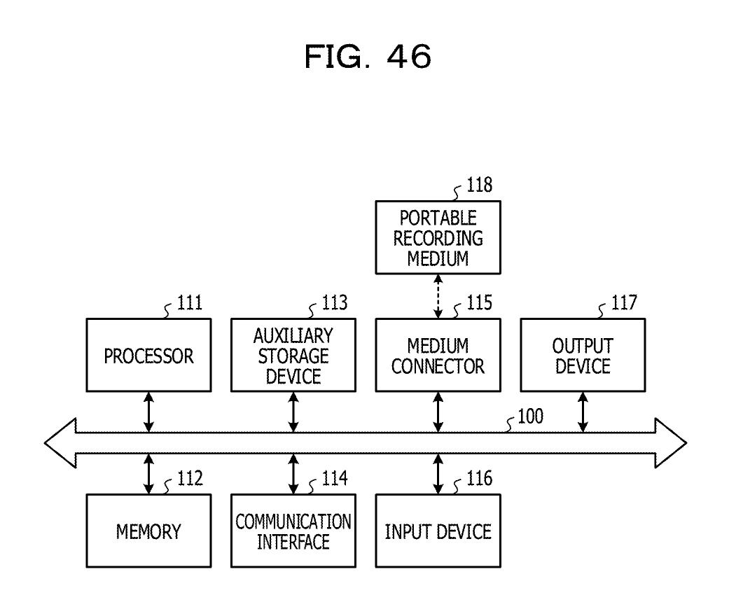

Next, description is given of an example of a hardware configuration of the information processor 1. FIG. 46 is a diagram illustrating an example of the hardware configuration of the information processor 1. As illustrated in the example of FIG. 46, a processor 111, a memory 112, an auxiliary storage device 113, a communication interface 114, a medium connector 115, an input device 116, and an output device 117 are connected to a bus 100 in the information processor 1.

The processor 111 executes a program developed in the memory 112. As the program to be executed, a data compression program to perform the processing of the embodiment may be applied.

The memory 112 is, for example, a random access memory (RAM). The auxiliary storage device 113 is a storage device that stores various information, and a hard disk drive, a semiconductor memory, or the like may be applied, for example. The data compression program to perform the processing of the embodiment may be stored in the auxiliary storage device 113.

The communication interface 114 is connected to a communication network, such as a local area network (LAN) and a wide area network (WAN), to perform data conversion and the like associated with communication.

The medium connector 115 is an interface capable of connecting to a portable recording medium 118. As the portable recording medium 118, an optical disk (for example, a compact disc (CD) and a digital versatile disc (DVD)), a semiconductor memory, and the like may be applied. The portable recording medium 118 may record the data compression program to perform the processing of the embodiment.

The input device 116 is, for example, a keyboard, a pointing device, or the like, and receives input of instructions, information and the like from a user.

The output device 117 is, for example, a display device, a printer, a speaker, or the like, and outputs an inquiry or instruction to the user, processing results, and the like.

The memory unit 17 illustrated in FIG. 10 may be realized by in the memory 112, the auxiliary storage device 113, the portable recording medium 118, or the like. The acquisition unit 11, the specification unit 12, the setting unit 13, the generation unit 14, the selection unit 15, the storage unit 16, the compression unit 18, the decompression unit 19, and the control unit 20 illustrated in FIG. 1 may be realized by the processor 111 executing the data compression program developed in the memory 112.

The memory 112, the auxiliary storage device 113, and the portable recording medium 118 are computer-readable non-transitory tangible storage media, rather than transitory media such as signal carriers.

<Others>

The embodiment is not limited to the one described above, but various changes, additions, and omissions may be made without departing from the scope of the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data compression method comprising:
specifying a structure of a group included in semistructured data, based on a data kind and a data type of each data in the group;
setting a first identifier unique to each structure and setting a second identifier for a pair of the data kind and the data type of each data in the structure;
storing the data in the group in different storage areas for each pair of the first identifier corresponding to the group and the second identifier corresponding to the data; and
compressing the data for each storage area.

2. The data compression method according to claim 1,
wherein, when the data is an array, the number of elements in the array and the elements in the array are stored in different storage areas.

3. The data compression method according to claim 1,
wherein, when the data is an array and elements in the array are groups, the first identifier different from the array is set for the group in the array, and
the number of the elements in the array, the first identifier set for the group in the array, and data in the group are stored in different storage areas.

4. The data compression method according to claim 1, further comprising:
generating a first tree by hierarchizing a plurality of the data kinds; and
retrieving, upon acquisition of a new group, a data kind in the acquired group from an upper level of the first tree, and adding the data kind to the first tree when the first tree does not include the data kind.

5. The data compression method according to claim 1, further comprising:
generating a second tree by hierarchizing a plurality of the structures; and
retrieving, upon acquisition of a new group, a structure of the acquired group from an upper level of the second tree, and adding the structure to the second tree when the second tree does not include the structure.

6. An apparatus for data compression, the apparatus comprising:
a memory; and
a processor coupled to the memory, the processor being configured to
execute a process that includes specifying a structure of a group included in semistructured data, based on a data kind and a data type of each data in the group,
execute a process that includes setting a first identifier unique to each structure and setting a second identifier for a pair of the data kind and the data type of each data in the structure,
execute a process that includes storing the data in the group in different storage areas for each pair of the first identifier corresponding to the group and the second identifier corresponding to the data, and
execute a process that includes compressing the data for each storage area.

7. The apparatus according to claim 6,
wherein, when the data is an array, the number of elements in the array and the elements in the array are stored in different storage areas.

8. The apparatus according to claim 6,
wherein, when the data is an array and elements in the array are groups, the first identifier different from the array is set for the group in the array, and
the number of the elements in the array, the first identifier set for the group in the array, and data in the group are stored in different storage areas.

9. The apparatus according to claim 6,
wherein the processor is further configured to
execute a process that includes generating a first tree by hierarchizing a plurality of the data kinds, and
execute a process that includes retrieving, upon acquisition of a new group, a data kind in the acquired group from an upper level of the first tree, and adding the data kind to the first tree when the first tree does not include the data kind.

10. The apparatus according to claim 6,
wherein the processor is further configured to
execute a process that includes generating a second tree by hierarchizing a plurality of the structures, and
execute a process that includes retrieving, upon acquisition of a new group, a structure of the acquired group from an upper level of the second tree, and adding the structure to the second tree when the second tree does not include the structure.

11. A non-transitory computer-readable storage medium for storing a program which causes a processor to perform processing for data compression, the processing comprising:
specifying a structure of a group included in semistructured data, based on a data kind and a data type of each data in the group;
setting a first identifier unique to each structure and setting a second identifier for a pair of the data kind and the data type of each data in the structure;
storing the data in the group in different storage areas for each pair of the first identifier corresponding to the group and the second identifier corresponding to the data; and
compressing the data for each storage area.

12. The non-transitory computer-readable storage medium according to claim 11,
wherein, when the data is an array, the number of elements in the array and the elements in the array are stored in different storage areas.

13. The non-transitory computer-readable storage medium according to claim 11,
wherein, when the data is an array and elements in the array are groups, the first identifier different from the array is set for the group in the array, and
the number of the elements in the array, the first identifier set for the group in the array, and data in the group are stored in different storage areas.

14. The non-transitory computer-readable storage medium according to claim 11,
wherein the processing further includes:
generating a first tree by hierarchizing a plurality of the data kinds; and
retrieving, upon acquisition of a new group, a data kind in the acquired group from an upper level of the first tree, and adding the data kind to the first tree when the first tree does not include the data kind.

15. The non-transitory computer-readable storage medium according to claim 11,
wherein the processing further includes:
generating a second tree by hierarchizing a plurality of the structures; and
retrieving, upon acquisition of a new group, a structure of the acquired group from an upper level of the second tree, and adding the structure to the second tree when the second tree does not include the structure.
